(19) United States
(12) Patent Application Publication
(10) Pub. No.: US 2008/0238155 A1
(43) Pub. Date: Oct. 2, 2008

(54) ILLUMINATED AUTOMOTIVE WIND BLOCKER

(76) Inventor: Robert King Pennington, Garland, TX (US)

Correspondence Address: BANOWSKY &LEVINE, P.C, 12001 N. CENTRAL EXPRESSWAY, SUITE 790, DALLAS, TX, 75243, US

(21) Appl. No.: 12/043,509

(22) Filed: Mar. 6, 2008

Related U.S. Application Data
(60) Provisional application No. 60/920,576, filed on Mar. 30, 2007.

(51) Int. Cl. B60J 9/04; F21V 33/00

(52) U.S. Cl. 296/217; 362/253

(57) ABSTRACT

The illuminated automotive wind blocker allows the simple and inexpensive manufacture of a wind blocker for any number of automobiles which utilize illuminated text and/or artwork. The design of the illuminated automotive wind blocker allows such text or artwork to be quickly and inexpensively applied based on customer requirements. The use of computer aided etching techniques allow the illuminated automotive wind blocker to be cost effectively manufactured with custom artwork in quantities as low as one item. This allows the end customer to utilize any artistic design desired to create a completely custom, one-of-a-kind accessory for the customer's automobile.

### CROSS-REFERENCE TO RELATED APPLICATIONS

This application claims priority to provisional application No. 60/920576, filed on Mar. 30, 2007, which application is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to an illuminated wind blocking device for convertible automobiles. Several wind blocking devices have been manufactured for convertibles, but the present invention is unique in that it incorporates text or art work which is abraded onto a solid flat transparent or translucent wind blocker and then illuminated.

### BRIEF SUMMARY OF THE INVENTION

The present invention provides a solid transparent or translucent wind blocker for convertible automobiles which is abraded with text or art work and illuminated.

The present invention provides a device which comprises a solid transparent or translucent panel with a face and an edge, a means for attaching the panel to a convertible, abrasion on the face of the panel and a means of illumination. The subject device is installed in a convertible automobile such that it projects upwards beyond a belt line of the body of the convertible and provides a customized artistic presentation while redirecting airflow through the passenger compartment of the automobile.

### BRIEF DESCRIPTIONS OF THE DRAWINGS

FIG. 1 is a preferred embodiment of the wind blocker positioned in a convertible automobile.

FIG. 2 is another preferred embodiment of the wind blocker.

FIG. 3 is another preferred embodiment of the wind blocker.

FIG. 4 is another preferred embodiment of the wind blocker.

FIG. 5 is another preferred embodiment of the wind blocker.

### DETAILED DESCRIPTION OF THE INVENTION

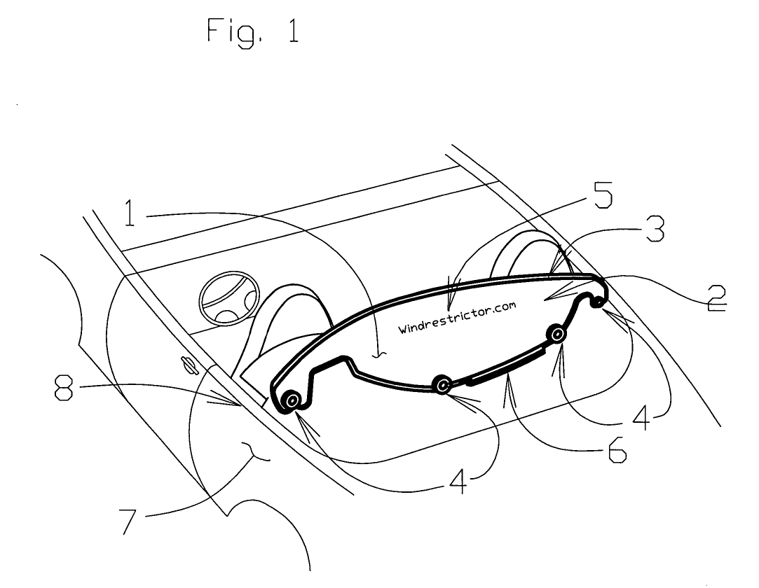

An illuminated automotive wind blocking device for a convertible automobile, a body 7 of which is illustrated in FIG. 1, comprising a flat solid transparent or translucent panel 1 which projects upwards beyond a belt line 8 of the body 7 of the convertible automobile and that has a face 2, an edge 3, a means for attaching the panel 1 to a convertible automobile 4, abrasion on the face of the panel 5, and means of illumination 6.

The illuminated automotive wind blocker is made in the following manner. In the preferred embodiment, the panel 1 is made from an acrylic plastic. In the preferred embodiment, the panel 1 is cut to a predetermined shape to fit into a particular convertible automobile to be arranged behind headrests of seats of the convertible automobile. In the preferred embodiment, the abrasion 5 is customized text and/or artistic design which is formed in the face 2 of the panel 1 by water pressure, sand blasting or laser etching, which allows each illuminated automotive wind blocker to be custom designed based upon a customer's requirements. In the preferred embodiment, the means of illumination is a strip of light emitting diodes (LEDs) which are readily known in the art and which are affixed to the edge 3 of the panel 1. Affixing the LED strip to the edge 3 of the panel 1 allows light to pass through the panel 1 and become diffused at the abrasion 5 such that the abrasion 5 is illuminated to observers.

Although it is desirable that the panel 1 of the illuminated automotive wind blocker be constructed of light weight, abrasion resistant materials, it should be understood that the panel 1 of the illuminated automotive wind blocker can be manufactured from any number of transparent or translucent materials that are known in the art. Additionally, while the preferred embodiment utilizes an LED strip for illumination, it should also be understood that the means of illuminating the abrasion could be any number of means of illumination known in the art and such illumination can be white, a single color, or multi-colored. The means of illumination can be powered by its own independent power source or powered by the convertible automobile's power system. In either case, the means of illumination can utilize its own switch to control the flow of electricity. However, if powered by the convertible automobile's power system, the means of illumination can also be connected to the convertible automobile's electrical system such that the convertible automobile's electrical system controls the flow of electricity such that the means of illumination may be always on, on when the vehicle's ignition switch is in the “accessory” or “on” position, or on when one or more of the convertible automobile's lights are on, such as the parking lights, brake lights or head lights.

Although it is anticipated that the abrasion will be formed by water pressure, sand blasting or laser etching, it should also be understood that the invention is not dependent on any particular manner of forming the abrasion 5. The formation of the abrasion 5 can be accomplished by any number of methods known to one skilled in the art.

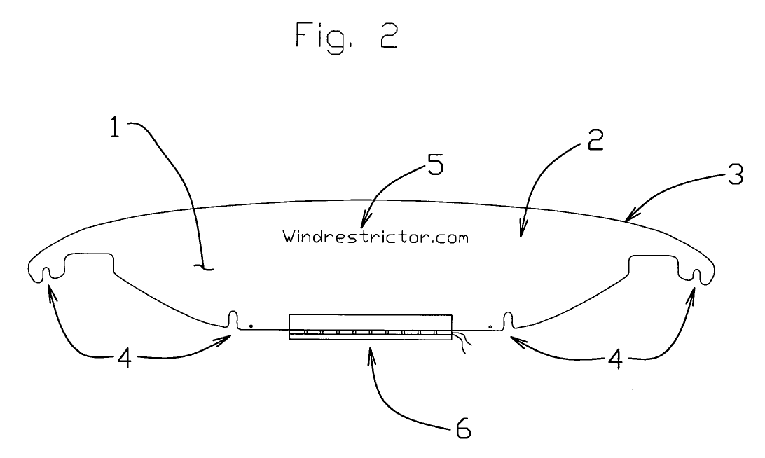

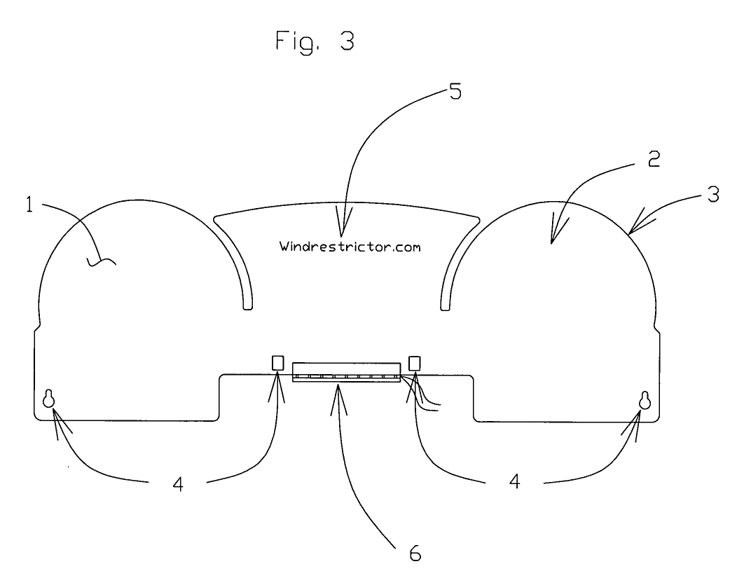

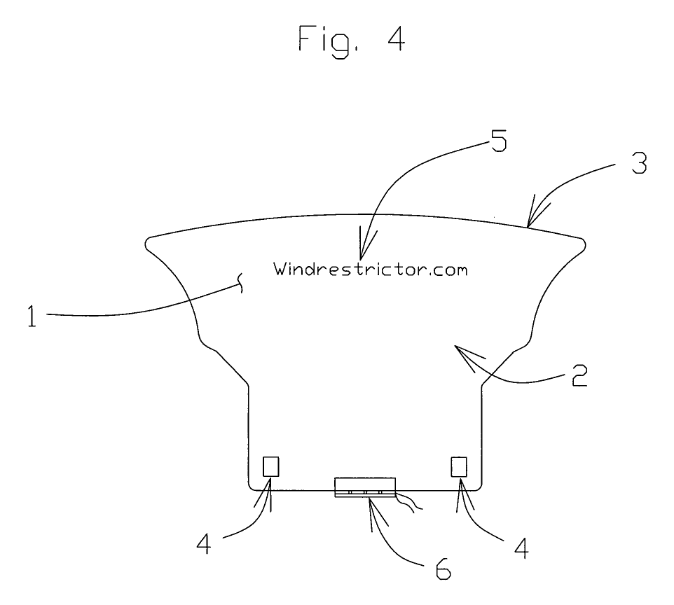

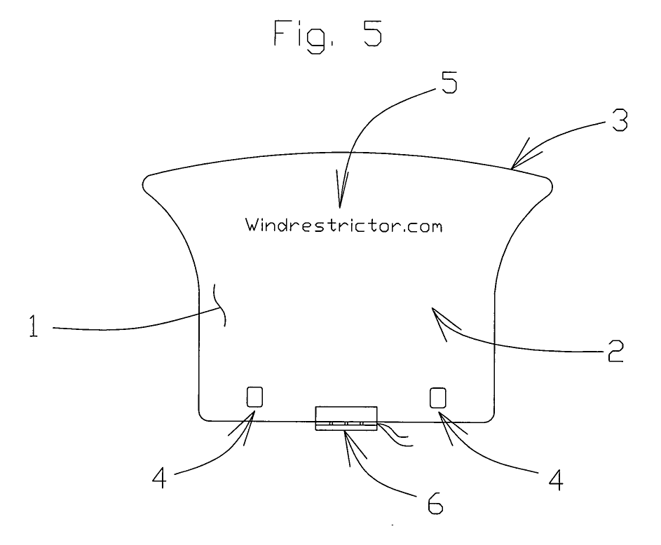

It should be understood that the geometry of the panel 1 in FIG. 1 is based upon the criteria for a particular convertible automobile. The geometry of the panel 1 can be easily modified to fit any number of convertible automobiles by one skilled in the art. FIG. 2 through FIG. 5 illustrate examples of other shapes for the panel 1 which are adapted to fit into different convertible automobiles. Likewise the means for attaching the panel 1 to the convertible automobile may vary from one type of automobile to another and the means for attaching the panel 1 to the convertible can be easily determined by one skilled in the art. In one preferred embodiment, the means for attaching the panel 1 to the convertible is a set of holes in the panel 1 through which mechanical fasteners are passed and used to secure the panel 1 to the convertible as illustrated in FIG. 3 thought FIG. 5. In another preferred embodiment, the means for attaching the panel 1 to the convertible is a set of slots in the panel 1 through which mechanical fasteners are passed to secure the panel 1 to the convertible as illustrated in FIG. 2.

Although the invention has been described in detail with reference to a particular embodiment, it is to be understood that variations or modifications may be made within the spirit and scope of the invention as defined in the appended claims.

What is claimed is:

1. An illuminated wind blocking device for a convertible comprising:
a wind blocker adapted to be arranged behind headrests of seats of said convertible and projecting upward beyond a belt line of said convertible, said wind blocker comprising:
a solid flat transparent or translucent panel having a face and an edge;
means for affixing said panel to said convertible;
abrasion on said face; and
means of illumination.

2. The illuminated wind blocking device of claim 1, wherein said panel is constructed of acrylic.

3. The illuminated wind blocking device of claim 1, wherein said means of illumination is light emitting diodes.

4. The illuminated wind blocking device of claim 1, wherein said means of illumination is electrically connected to an electrical circuit of the convertible.

5. The illuminated wind blocking device of claim 1, wherein said means of illumination is electrically connected to a brake light circuit of the convertible.

6. The means of illumination of claim 3 wherein said light emitting diodes are arranged in a strip.

7. The means of illumination of claim 3 wherein said light emitting diodes are affixed to the edge of the panel.

8. The illuminated wind blocking device of claim 1, wherein said abrasion is laser etched.

9. The illuminated wind blocking device of claim 1, wherein said abrasion is sand blasted.

10. The illuminated wind blocking device of claim 1, wherein said abrasion is formed by water pressure.
